(19) United States
(12) Patent Application Publication
(10) Pub. No.: US 2023/0356754 A1
(43) Pub. Date: Nov. 9, 2023

(54) Control Mode Selection And Transitions

(71) Applicant: APPLE INC., Cupertino, CA (US)

(72) Inventors: Libo Cao Meyers, San Jose, CA (US); Joseph K. Walnes, Los Gatos, CA (US)

(21) Appl. No.: 18/224,846

(22) Filed: Jul. 21, 2023

Related U.S. Application Data
(63) Continuation of application No. PCT/US2022/013222, filed on Jan. 21, 2022.
(60) Provisional application No. 63/143,441, filed on Jan. 29, 2021.

(51) Int. Cl. B60W 60/00; B60W 40/08; G05D 1/00

(52) U.S. Cl. CPC B60W 60/0059; B60W 60/0051; B60W 40/08; G05D 1/0022; B60W 2540/229; B60W 2556/45

(57) ABSTRACT

A computer-implemented method includes selection of a control mode for a device and transitions for a control mode for the device. Transitions between control modes may be based on a likelihood that a current control mode will become unavailable.

### CROSS-REFERENCE TO RELATED APPLICATIONS

This application is a continuation of International Application No. PCT/US2022/013222, filed on Jan. 21, 2022, which claims the benefit of U.S. Provisional Application No. 63/143,441, filed on Jan. 29, 2021, the contents of which are incorporated herein by reference for all purposes.

### FIELD

The present disclosure relates generally to the field of device control.

### BACKGROUND

Some devices can be controlled manually by a user, under autonomous control by an automated system, or under remote control by an operator at a remote location.

### SUMMARY

One aspect of the disclosure is a computer-implemented method for providing teleoperation service. The method includes receiving information that describes a trip to be made by a vehicle from a start location to a destination location, and determining disengagement prediction information that describes a likelihood that an autonomous control system will be unable to control the vehicle in an autonomous control mode during one or more portions of the trip. The method also includes presenting teleoperation service information to a user based on the disengagement prediction information, wherein the user may accept an offer of teleoperation service based on the teleoperation service information. In accordance with an input indicating acceptance of the offer of teleoperation service by the user, the method also includes transitioning the vehicle during the trip from the autonomous control mode to a teleoperation control mode in response to a predicted disengagement or actual disengagement of the autonomous control mode during the trip.

In the method of providing teleoperation service, determining the disengagement prediction information may be based on an autonomous control coverage map. Determining the disengagement prediction information may be based on historical trip information that describes disengagement events during previous trips by other vehicles. Determining the disengagement prediction information may include determining the predicted weather conditions for the trip. The teleoperation service information may include a teleoperation service cost for the trip and the input indicating acceptance of the offer of teleoperation service by the user may include an agreement to pay the teleoperation service cost.

In some implementations of the method for providing teleoperation service, the predicted disengagement is determined when a real-time disengagement likelihood metric exceeds a threshold value. The real-time disengagement likelihood metric may be determined based on sensor information that is received from a sensor system of the vehicle during the trip. The real-time disengagement likelihood metric may be expressed as a probability that the autonomous control mode of the vehicle will disengage within a predetermined period. The method may also include autonomously navigating towards the destination location while monitoring the real-time disengagement likelihood metric in accordance with the input indicating acceptance of the offer of teleoperation service by the user.

Another aspect of the disclosure is a non-transitory computer-readable storage device including program instructions, that, when executed by one or more processors, cause the one or more processors to perform operations for providing teleoperation service. Another aspect of the disclosure is an apparatus for providing teleoperation service that includes a memory and one or more processors that are configured to execute instructions that are stored in the memory.

Another aspect of the disclosure is a method for transitioning between control modes. The method includes determining a predicted disengagement of an autonomous control mode of a vehicle, outputting a notification to a user requesting transition of the vehicle from the autonomous control mode to a manual control mode, and determining that a threshold condition has been satisfied without transition of the vehicle to the manual control mode. In accordance with the determination that the threshold condition has been satisfied without transition of the vehicle to the manual control mode, the method also includes transitioning the vehicle to a teleoperation control mode.

In the method for transitioning between control modes, the predicted disengagement may be determined when a real-time disengagement likelihood metric exceeds a threshold value. The real-time disengagement likelihood metric may be determined based on sensor information that is received from a sensor system of the vehicle. The real-time disengagement likelihood metric may be determined based on information describing disengagement events experienced by other vehicles. The real-time disengagement likelihood metric may be determined based on weather conditions in an environment around the vehicle. The real-time disengagement likelihood metric may be expressed as a probability that the autonomous control mode of the vehicle will disengage within a predetermined period. The method may also include autonomously navigating towards a destination location while monitoring the real-time disengagement likelihood metric prior to determining the predicted disengagement of the autonomous control mode of the vehicle.

In the method for transitioning between control modes, outputting the notification to the user requesting transition of the vehicle from the autonomous control mode to the manual control mode may include at least one of emitting a sound, emitting a visual indication, or emitting a haptic indication. Outputting the notification to the user requesting transition of the vehicle from the autonomous control mode to the manual control mode may include transmitting a command that causes the notification to be output by a device that is carried by the user. Determining that the threshold condition has been satisfied without transition of the vehicle to the manual control mode may include determining that a predetermined time period has passed. Determining that the threshold condition has been satisfied without transition of the vehicle to the manual control mode may include determining that a real-time disengagement likelihood metric exceeds a threshold value. Determining that the threshold condition has been satisfied without transition of the vehicle to the manual control mode may include determining, based on sensor information from sensors that are located in a passenger cabin of the vehicle, that the user is not responding. In the teleoperation control mode, the vehicle may receive and execute instructions for control of vehicle operation from a remote human operator.

Another aspect of the disclosure is a non-transitory computer-readable storage device including program instructions, that, when executed by one or more processors, cause the one or more processors to perform operations for transitioning between control modes. Another aspect of the disclosure is an apparatus for transitioning between control modes that includes a memory and one or more processors that are configured to execute instructions that are stored in the memory.

Another aspect of the disclosure is a computer-implemented method for initiation of a teleoperation service. The method includes receiving requests for initiation of teleoperation service that are transmitted to a teleoperation service from vehicles, wherein at least some of the requests include real-time disengagement likelihood metrics that describe a likelihood that an autonomous control mode will be disengaged. The method also includes determining, for each of the requests for initiation of the teleoperation service, a ranking score, wherein the ranking scores are based in part on the real-time disengagement likelihood metrics, and selecting one of the vehicles for initiation of a teleoperation control mode according to the ranking score for the respective one of the vehicles. In accordance with the selection of the respective one of the vehicles for initiation of the teleoperation control mode, the method also includes operating the respective one of the vehicles in the teleoperation control mode by transmitting teleoperation commands to the respective one of the vehicles.

In the method for initiation of a teleoperation service, the real-time disengagement likelihood metrics may be determined by the vehicles based on sensor information. The real-time disengagement likelihood metrics may be determined based on information describing disengagement events experienced by other vehicles. The real-time disengagement likelihood metrics may be determined based on weather conditions in an environment around respective ones of the vehicles. The real-time disengagement likelihood metrics may each be expressed as a probability that the autonomous control mode will be disengaged within a predetermined period. The ranking scores may be based in part on an elapsed time since the request for initiation of the teleoperation service was made. Operating the respective one of the vehicles in the teleoperation control mode by transmitting the teleoperation commands to the respective one of the vehicles may be performed by a human operator using an operator system that is associated with the teleoperation service.

Another aspect of the disclosure is a non-transitory computer-readable storage device including program instructions, that, when executed by one or more processors, cause the one or more processors to perform operations for initiation of a teleoperation service. Another aspect of the disclosure is an apparatus for initiation of a teleoperation service that includes a memory and one or more processors that are configured to execute instructions that are stored in the memory.

### BRIEF DESCRIPTION OF THE DRAWINGS

FIG. 1 is a block diagram of a system in accordance with some embodiments.

FIG. 2 is a block diagram of a device in accordance with some embodiments.

FIG. 3 is a block diagram of operation of the device in accordance with some embodiments.

FIG. 4 is a block diagram of operation of a service in accordance with some embodiments.

FIG. 5 is a block diagram of a process for determination of a disengagement prediction in accordance with some embodiments.

FIG. 6 is a block diagram of a process for determination of a real-time disengagement likelihood metric in accordance with some embodiments.

FIG. 7 is a block diagram of a process for providing a teleoperation service in accordance with some embodiments.

FIG. 8 is a block diagram of a process for transitioning between control modes in accordance with some embodiments.

FIG. 9 is a block diagram of a process for initiation of a teleoperation service in accordance with some embodiments.

FIG. 10 is a block diagram of an exemplary computing device in accordance with some embodiments.

### DETAILED DESCRIPTION

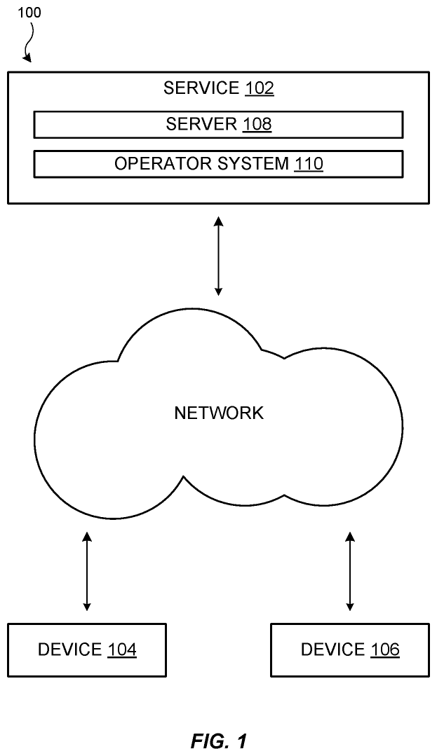

FIG. 1 is a block diagram of a system 100 for teleoperation of a device. The system 100 includes a teleoperation service 102 and devices 104 and 106. The teleoperation service 102, the device 104, and the device 106 each include computing functionality and communications functionality. The teleoperation service 102, the device 104, and the device 106 may communicate (e.g., by transmission of signals and/or data) with each other using wired or wireless connections and using any type of communications network, such as the Internet. In some embodiments, the device 104 is a vehicle, and the device 106 is a smart cellular phone.

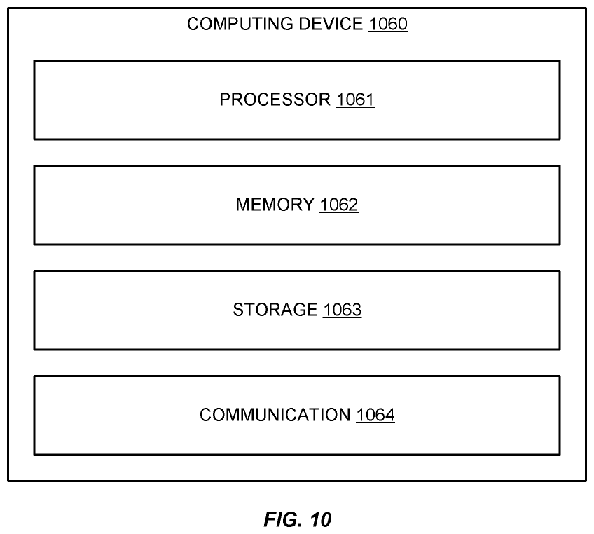

The teleoperation service 102 is a computer-implemented system that is configured to control operation of the device 104 from a remote location. Control of the device 104 may be initiated from the device 104, the device 106, or from the teleoperation service 102. The teleoperation service 102 includes teleoperation server 108 and an operator system 110. The teleoperation server 108 and the operator system 110 may be implemented using computing devices that are configured to execute computer program instructions that facilitate the functions that will be described herein. The teleoperation service 102 can receive and use information that is supplied by the user (e.g., a passenger), which may be supplied through the device 104, the device 106, or in another manner. The teleoperation service 102 can receive and use information that is transmitted from the device 104, such as signals and data, and this information can be used as a basis for controlling the device 104 using the operator system 110. Using the information that is received from the device 104, a human operator can control the device 104 by providing control inputs to the operator system 110 using an interface device that is associated with the operator system 110. The teleoperation service 102 may include a large number (e.g., thousands) of the operator systems, of which the operator system 110 is representative. Operation of the teleoperation service 102 will be described further herein. Operations and functions that are described herein with reference to the teleoperation service 102 may be performed by the teleoperation server 108. In some implementations, the teleoperation server 108 employs an exemplary computing device 1060 described with reference to FIG. 10, below.

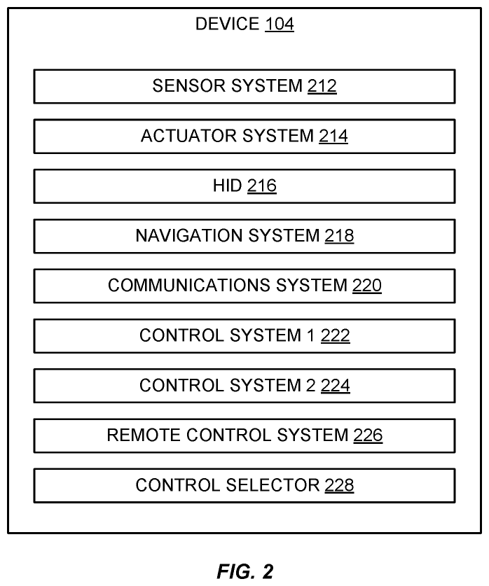

FIG. 2 is a block diagram of a device 104, which in some embodiments is a road-going vehicle (e.g., supported by wheels and tires) that is configured to carry passengers and/or cargo. In some examples, the device 104 includes a sensor system 212, an actuator system 214, a human interface device (HID) interface 216, a navigation system 218, a communications system 220, a local manual system 222 (also referred to as control system 1), a local autonomous system 224 (also referred to as control system 2), a remote control system 226, and a control selector 228. These components are attached to and/or form parts of a physical structure of the device 104, such as a body or frame, and are electrically interconnected to allow transmission of signals, data, commands, etc., between them, either over wired connections, (e.g., using a wired communications bus) or over wireless data communications channels. Other components may be included in the device 104, including chassis, body, suspension, actuator, power system components, so forth.

The sensor system 212 includes one or more sensor components that are able to collect information that describes the environment around the device 104 and/or information that describes operating conditions of the device 104. The information may be in the form of sensor signals that can be interpreted to understand features of the environment and/or states of the device 104. The sensor signals may include two-dimensional images and/or three-dimensional scans of the environment. The information may include measurements and observations regarding the environment. This information may be referred to as environment information. The sensor signals may include two-dimensional images and/or three-dimensional scans of a passenger cabin of the device 104. The information may include measurements and observations regarding the passenger cabin of the device 104. This information may be referred to as passenger cabin information. The information may include measurements and observations regarding the components of the device 104. This information may be referred to as device information. Exemplary sensors in the sensor system 212 for information include imaging devices such as still cameras in the visible spectrum or the infrared spectrum, video cameras, Lidar or other depth sensors, Radar sensors, GPS sensors, inertial measurement units, position sensors, angle sensors, speed sensors, torque sensors, force sensors, so forth.

The actuator system 214 includes one or more actuator components that are able to affect motion of the device 104. The actuator components can accelerate, decelerate, steer, or otherwise influence motion of the device 104. These components can include suspension actuators, steering actuators, braking actuators, and propulsion actuators (e.g., one or more electric motors).

The actuator system 214 may be controlled by commands received from the local manual system 222 in a manual control mode. As an example, the local manual system 222 can output commands to the actuator system 214 that cause the actuator system 214 to move the device 104. The actuator system 214 may be controlled by commands received from the local autonomous system 224 in an autonomous control mode. As an example, the local autonomous system 224 can output commands to the actuator system 214 that cause the actuator system 214 to move the device 104. The actuator system 214 may be controlled by commands received from the remote control system 226 in a teleoperation control mode. As an example, the remote control system 226 can output commands to the actuator system 214 that cause the actuator system 214 to move the device 104.

The HID interface 216 includes components that allow a user to interact with various system of the device 104. The HID interface 216 includes input devices and output devices. Examples of the HID interface 216 include display screens, touch-sensitive interfaces, gesture interfaces, audio output devices, voice command interfaces, buttons, knobs, control sticks, control wheels, pedals, so forth. The HID interface 216 may allow the user to control the navigation system 218, such as by specifying a destination for the device 104.

The navigation system 218 may include location determining functionality, mapping functionality, and route planning functionality. As an example, the navigation system 218 may include a satellite positioning system receiver to determine a current location of the device 104. The navigation system 218 is also configured to determine and/or display one or more routes from a current location to a destination including display of geographic areas near the one or more routes.

The navigation system 218 may be operable to receive a route from the user (e.g., passenger), to receive a route from an external route planning system, or to plan a route based on user inputs. As an example, the navigation system may use a routing algorithm of any type to determine a route from an origin location (e.g., a current location or a user-specified location) to a destination location. The route may be determined locally by the navigation system 218 using an on-board routing algorithm or may be determined remotely (e.g., by a navigation routing server). The route may be stored in any suitable data format, for example, a list of map segments or road segments that connect the origin location to the destination location.

The communications system 220 allows signals carrying data to be transmitted from the device 104 to remote systems and/or received at the device 104 from remote systems. Any suitable communications protocol and/or technology may be utilized to implement the communications system 220, such as cellular protocols. As an example, the communications system 220 allows real-time communications between the device 104 and a remote location to allow remote operation of the device 104 using the remote control system 226.

The local manual system 222 is a manual control system that is located in the device 104 and allows a person who is present in the device 104 (e.g., a passenger) to control operation of the actuator system 214 by providing control inputs through the HID interface 216. The local manual system 222 can receive inputs from the person through the HID interface 216 indicating, as examples, throttle (e.g., propulsion) commands, steering commands, and braking commands. These inputs are interpreted by the local manual system 222 and used to control the components of the actuator system 214.

The local autonomous system 224 is an autonomous control system that is located in the device 104, is configured to make decisions regarding motion of the device 104, and is configured to control operation of the actuator system 214 so that the device 104 moves in accordance with those decisions. The local autonomous system 224 performs perception, planning, and control functions. These functions may be incorporated in hardware, firmware, and/or software systems. As an example, the local autonomous system 224 can be implemented in the form of one or more computing devices that are provided with control software that includes computer program instructions that allow the local autonomous system 224 to perform the above-described functions. In some implementations, the local autonomous system 224 employs the exemplary computing device 1060 described with reference to FIG. 10, below.

Perception functions of the local autonomous system 224 include interpreting the sensor outputs from the sensor system 212 and identifying features in the sensor outputs that are usable for controlling the device 104. Motion planning functions of the local autonomous system 224 include determining how to move the device 104 in order to achieve an objective, such as by determining a trajectory for the device 104. The trajectory for the device 104 is based in part on a route determined by the navigation system 218. Motion control functions of the local autonomous system 224 include commanding the actuator system 214 and/or other systems of the device 104 in accordance with the decisions made by the motion planning functions, such as by controlling the actuator system 214 in a manner that causes the device 104 to follow the trajectory determined by the motion planning functions to travel towards a destination.

The remote control system 226 allows the device 104 to be controlled by a remote human operator from a remote location relative to the device 104, such as by use of the operator system 110 of the teleoperation service 102. The remote control system 226 sends information obtained by the sensor system 212 to the teleoperation service 102 using the communications system 220 so that the information may be viewed by the remote human operator via the operator system 110, and used by the remote human operator to make control inputs using an HID interface that is located at the remote location, such as by using an input device that is associated with the operator system 110. The remote control system 226 receives information from the teleoperation service 102 using the communications system 220. The information from the teleoperation service 102 may include commands that are interpreted by the remote control system 226 and passed to the actuator system 214 to cause operation of the actuator system 214 in accordance with control inputs made by the remote human operator at the operator system 110.

The control selector 228 is configured to determine whether to operate the device 104 in the manual control mode, the autonomous control mode, or the teleoperation mode. The control selector 228 may change the control mode in response to a command received from the user. The control selector 228 may change the control mode in response to a command received from another system of the device 104, such as the local autonomous system 224. The control selector 228 may change the control mode in response to a command received from an external system, such as the teleoperation server 108 of the teleoperation service 102. The control selector 228 may change the control mode programmatically in response to a determination made by the control selector 228 using a rule, algorithm, or other decision making framework.

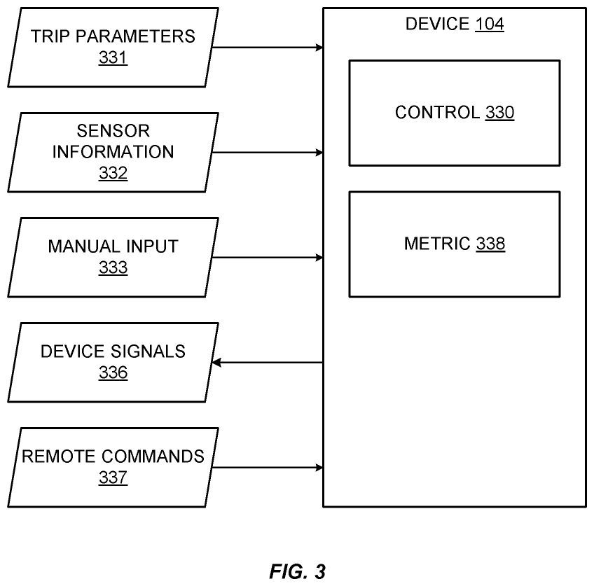

FIG. 3 is a block diagram of operation of the device 104. The device 104 determines control commands 330, which are used to control components of the device 104 such as the actuator system 214. As inputs, the device 104 can receive trip parameters 331, sensor information 332, and manual control input 333. To facilitate operation of the device 104 in the teleoperation control mode, the device 104 can transmit information to the teleoperation service 102 including device signals 336 and receive information from the teleoperation service 102 including teleoperation commands 337.

The control commands 330 can be determined using the local manual system 222 in the manual control mode based on control inputs from a user who is located in the device 104, the control commands 330 can be determined using the local autonomous system 224 in the autonomous control mode to travel toward a destination location that is selected by the user or by another system, or the control commands 330 can be determined using the remote control system 226 in the teleoperation control mode based on control inputs from an operator at a remote location, for example, by use of the operator system 110 of the teleoperation service 102. The control selector 228 of the device 104 is responsible for selecting the source of the control commands, and the control commands 330 are routed from the selected source to the systems being controlled, such as the actuator system 214.

The trip parameters 331 describe a trip, which may be a planned trip that is intended to occur in the future or may be a current trip that the device 104 is currently engaged in. The trip parameters may include a start location and a destination location. The start location indicates an expected location of the device 104 at the beginning of the trip. The destination location indicates an expected location of the device 104 at the end of the trip, or may indicate a midpoint location in the case of a round trip. The start location and the destination location are geographic locations that may be indicated in any conventional form, such as by place names, addresses, or geospatial coordinates. The trip parameters 331 may also include information that describes planned stops for the planned trip, between the start location and the destination location. The trip parameters 331 also include a time period during which a future trip will occur, including start times and end times. The trip parameters 331 may include a planned travel route that includes travel between the start location and the destination location. In some implementations, the planned travel route is not provided by the user and is instead determined according to the start location, the destination location, and/or other information. The planned route may be determined by the navigation system 218, by a component of the teleoperation service 102, or by another system or service.

The sensor information 332 includes signals and/or data obtained from sensor devices that are included in the sensor system 212. The sensor information 332 can be presented to the user, for example, as a basis for manual control using the local manual system 222. The sensor information 332 can be interpreted and used by the local autonomous system 224 as a basis for autonomous control. The sensor information 332 may also be forward to the teleoperation service 102 as part of the device signals 336 and/or used as a basis for determining part of the device signals 336, either alone or in combination with other information.

The manual control input 333 is information that represents input made by the user for the purpose of operating the device 104. The manual control input 333 can be obtained from the HID interface 216 of the device 104 or from another input device that is associated with the device 104. The manual control input 333 can be used by the local manual system 222 for determining the control commands 330.

The device signals 336 are transmitted to the teleoperation service 102 for the purpose of allowing control of the device 104 by the teleoperation service 102 using the remote control system 226 in the teleoperation control mode. Raw information or interpreted information from the sensor information 332, obtained using any sensors from the sensor system 212 or obtained otherwise, may be included in the device signals 336 that are transmitted to the teleoperation service 102. As one example, the device signals 336 can include a video stream (e.g., a series of images) that is transmitted to the teleoperation service 102 for display using the operator system 110 so that the operator of the operator system 110 can see the environment around the device 104. As another example, a point cloud determined using three-dimensional sensors (e.g., Lidar sensors) may be transmitted to the teleoperation service 102 to be interpreted and/or displayed by the operator system 110. As another example, the device signals 336 can include environment information that is determined using the sensor information 332, such as locations and identities of objects that are near the device 104, which can be determined using an object detection function of the device 104. As another example, the device signals 336 can include information determined by the local autonomous system 224 of the device 104, such as a motion plan or proposed command signals determined by the local autonomous system 224. This information can then by reviewed by the human operator at the operator system 110 of the teleoperation service 102 for use in remote manual control and for use in assessing the ability of the local autonomous system 224 to resume control of the device 104 in the autonomous control mode.

The teleoperation commands 337 are information that represent input made by the operator of the operator system 110 of the teleoperation service 102 for the purpose of operating the device 104 remotely using the remote control system 226 in the teleoperation control mode of the device 104. The teleoperation commands 337 can be obtained from an interface device that is associated with the operator system 110. The teleoperation commands 337 are transmitted from the teleoperation service 102 to the device 104, for example, using a wireless data connection (e.g., a cellular data connection). The teleoperation commands 337 can be used by the remote control system 226 of the device 104 for determining the control commands 330.

The real-time disengagement likelihood metric 338 is determined by the device 104 during the trip based on information that is available to the device 104, including real-time information about the environment around the device 104 and operating conditions of the device 104. The real-time disengagement likelihood metric 338 may be determined by the control selector 228 in order to initiate a change in the current control mode from the autonomous control mode to the manual control mode or the teleoperation control mode before the local autonomous system 224 becomes unable to continue autonomous control of the device 104 and disengages the autonomous control mode. In some situations, the control selector 228 can use the real-time disengagement likelihood metric 338 to direct a transition from the autonomous control mode to the manual control mode, to direct a transition from the autonomous control mode to the teleoperation control mode, or to direct the local autonomous system 224 to stop the device 104 at a safe location until travel can safely continue in one of the control modes.

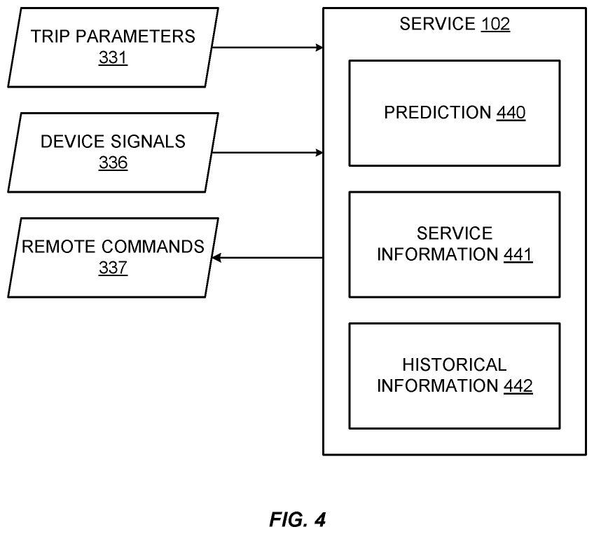

FIG. 4 is a block diagram of operation of the teleoperation service 102. Inputs that are provided to the teleoperation service 102 can include the trip parameters 331 from the device 104 and the device signals 336 from the device 104. The teleoperation commands 337 are determined by the teleoperation service 102 and transmitted to the device 104 for operation of the device 104 in the teleoperation control mode. The teleoperation service 102 is configured to determine disengagement prediction information 440 and teleoperation service information 441. The device 104 may include stored information 442 that is collected from many devices with consent from the respective users and used to determine the disengagement prediction information 440 and/or the teleoperation service information 441. The disengagement prediction information 440 can be determined by the teleoperation service 102 before a trip as a basis for determining the teleoperation service information 441, and expresses a likelihood of a disengagement event during a future trip of the device 104, such as the trip described by the trip parameters 331. The teleoperation service information 441 includes information that describes a service that can be provided to the device 104 by the teleoperation service 102 in order to control the device 104 in the teleoperation control mode if the autonomous control mode becomes unavailable. The teleoperation service information 441 may include a price for the teleoperation service during a specific planned trip that is defined by a time for the planned trip (e.g., a date range, a start time, and/or an end time), start and end locations for the planned trip, and/or a route for the planned trip.

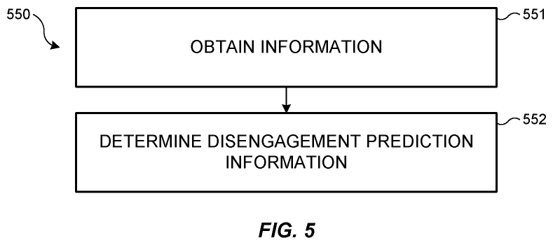

FIG. 5 illustrates exemplary process 550 for determination of the disengagement prediction information 440. The process 550 includes operations that can be performed by a computer-implemented system, such as the teleoperation service 102 and/or the device 104. In some implementations, the computer-implemented system that performs the process 550 has a memory that contains computer program instructions and one or more processors that are configured to execute the computer program instructions to cause the one or more processors to perform the operations of the process 550. The process 550 may include any of the features described herein, inclusive of the inputs, outputs, and models described with reference to FIGS. 3-4.

The disengagement prediction information 440 expresses a likelihood of a disengagement event during a future trip of the device 104. A disengagement event represents an occurrence of the local autonomous system 224 of the device 104 disengaging such that it is no longer exercising control over the device 104 in the autonomous control mode. The information used in determining the disengagement prediction information 440 can be specific to a route or a portion of a route. The information used in determining the disengagement prediction information 440 can include the stored information 442 from the teleoperation service 102, such as historical information of disengagements by other devices (e.g., vehicles), whether in the same geographic areas as are included in the route, under conditions (e.g., weather) similar to those expected for the future trip, or otherwise.

Operation 551 includes obtaining information for use in predicting a likelihood of disengagement of the local autonomous system 224 of the device 104 during a future trip or a portion of a future trip. As examples, the information obtained in operation 551 can include information from the device 104, such as the trip parameters 331, and can include the stored information 442 from the teleoperation service 102.

Some of the information obtained in operation 551 can be independent of the locations and routes that will be traveled upon during the trip. As an example, information describing disengagement events experienced by the device 104 or similar devices (e.g., in the form of aggregated statistics) under specific conditions can be obtained in operation 551, for example, from the stored information 442 of the teleoperation service 102. This may include statistics describing a likelihood of disengagement under specific types of weather conditions or a likelihood of disengagement at specific times of day. Some of the information obtained in operation 551 can be obtained based on the start location for the trip, the destination location for the trip, and/or the planned route that will be used during the trip. As one example, the stored information 442 from the teleoperation service 102 may include an autonomous control coverage map that identifies locations where it is known that autonomous control is not available. As another example, the information may include, for portions of the route to be taken during the trip, historical trip information from the stored information 442 that describes disengagement events during previous trips by other devices. As another example, the information may include expected conditions along the planned route during the trip, such as expected weather conditions, expected traffic conditions, and/or special events that may change traffic control patterns.

Operation 552 includes determining the disengagement prediction information 440. The disengagement prediction information 440 is determined using the information obtained in operation 551. The disengagement prediction information 440 may include a single prediction for the trip, or may include multiple predictions that each express a likelihood of disengagement during a portion of the trip. Based on the likelihood of disengagement and the lengths of the portions of the trip that such likelihoods exist, an estimated total time or distance over which the autonomous control mode will be unavailable can be determined and included in the disengagement prediction information 440. As one example, the disengagement prediction information 440 may be determined using a statistical model that determines a probability of disengagement of the autonomous control mode during the trip. As another example, multiple iterations of simulated trips may be performed using a computer-implemented simulation model to determine a probability of disengagement of the autonomous control mode during the trip. As another example, a trained neural network can be configured to determine a probability of disengagement of the autonomous control mode during the trip based on the information obtained in operation 551.

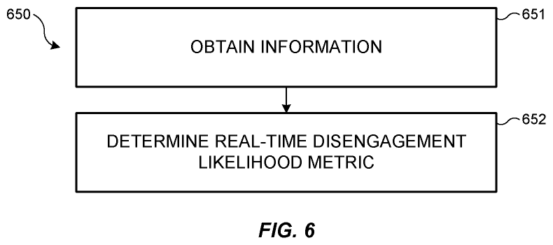

FIG. 6 illustrates exemplary process 650 for determination of the real-time disengagement likelihood metric 338. The process 650 includes operations that can be performed by a computer-implemented system, such as the teleoperation service 102 and/or the device 104. In some implementations, the computer-implemented system that performs the process 650 has a memory that contains computer program instructions and one or more processors that are configured to execute the computer program instructions to cause the one or more processors to perform the operations of the process 650. The process 650 may include any of the features described herein, inclusive of the inputs, outputs, and models described with reference to FIGS. 3-4.

The real-time disengagement likelihood metric 338 describes a likelihood of a disengagement event in the immediate future during a trip by the device 104. In addition to use of the same information used to determine the disengagement prediction information 440 as described in the process 650, the real-time disengagement likelihood metric 338 can be further based on current conditions that are being experienced by the device 104.

Operation 651 includes obtaining information for use in determining the real-time disengagement likelihood metric 338. In addition to the information described in operation 651, sensor information 332 from the sensor system 212 can be obtained, for example, showing real-time conditions around the device 104 such as weather conditions, objects near the device 104, and compromised conditions of sensors from the sensor system 212 such as dirty or fogged camera lenses.

Operation 652 includes determining the real-time disengagement likelihood metric 338. The real-time disengagement likelihood metric 338 may be determined based on sensor information that is received from the sensor system 212 of the device 104. The real-time disengagement likelihood metric 338 may be determined based on information describing disengagement events experienced by other devices as described with respect to the process 550. The real-time disengagement likelihood metric 338 may be determined based on weather conditions in an environment around the device 104. The real-time disengagement likelihood metric 338 may be expressed as a probability that the local autonomous system 224 of the device 104 will disengage the autonomous control mode in the immediate future, such as within a predetermined time period or a predetermined distance of travel after determination of the real-time disengagement likelihood metric 338. As described with respect to operation 552 of the process 550, the real-time disengagement likelihood metric 338 may be determined by statistical methods, by a simulation model, by a trained neural network, so forth.

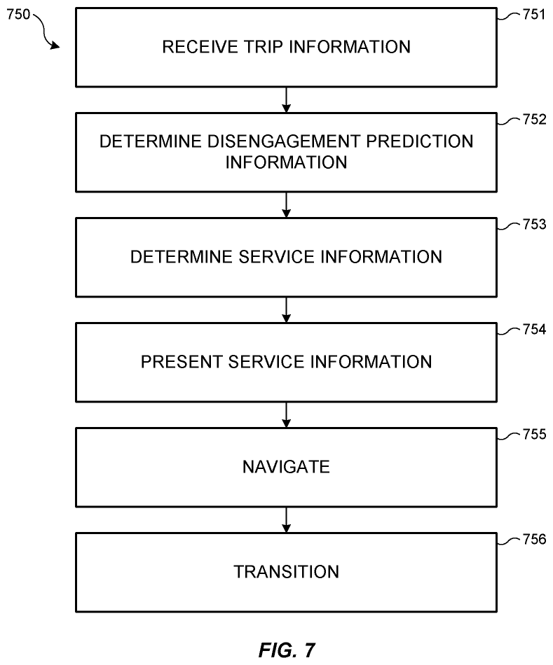

FIG. 7 illustrates exemplary process 750 for providing teleoperation service. The process 750 includes operations that can be performed by a computer-implemented system, such as the teleoperation service 102 and/or the device 104. In some implementations, the computer-implemented system that performs the process 750 has a memory that contains computer program instructions and one or more processors that are configured to execute the computer program instructions to cause the one or more processors to perform the operations of the process 750. The process 750 may include any of the features described herein, inclusive of the inputs, outputs, and models described with reference to FIGS. 3-4.

Operation 751 includes receiving information that describes a trip to be made by the device 104 from a start location to a destination location. The information may be in the form described with respect to the trip parameters 331. Operation 752 includes determining disengagement prediction information 440 that describes a likelihood that an autonomous control system will be unable to control the device 104 in an autonomous control mode during one or more portions of the trip. Operation 752 can be implemented in the manner described with respect to the process 550 for determination of disengagement prediction information 440 and using the information obtained in operation 751.

Operation 753 includes determining the teleoperation service information 441. Based on the disengagement prediction information 440 from operation 752, the teleoperation service 102 analyzes the likelihood of disengagement of the local autonomous system 224 during the trip and/or an estimated duration during which the autonomous control mode will be unavailable during the trip. This information is included in the teleoperation service information 441 and a price at which the teleoperation service 102 will provide teleoperation services to the device 104 during the trip is also included in the teleoperation service information 441. The price may be determined based on the likelihood of disengagement of the local autonomous system 224 for portions of the trip or all of the trip and/or estimated times or distances over which the autonomous control mode of the device 104 will be unavailable.

Operation 754 includes presenting the teleoperation service information 441 to a user based on the disengagement prediction information 440. The teleoperation service information 441 may include a teleoperation service cost for the trip, may include an offer of teleoperation service to the user for the trip, and may prompt the user to indicate acceptance or rejection of the offer. A user input indicating acceptance of the offer of teleoperation service by the user includes an agreement, by the user, to pay the teleoperation service cost that is presented to the user as part of the teleoperation service information 441. The teleoperation service information 441 may be presented to the user using the HID interface 216 of the device 104, using an interface associated with the device 106, or using another device.

In response to presenting the teleoperation service information 441 to the user in operation 754 the user may indicate that they reject or accept the offer of teleoperation service. This indication may be made with a user interface, such as the HID interface 216 of the device 104 or an interface of the device 106. Thus, for example, the user may accept an offer of teleoperation service based on the teleoperation service information 441 by making an input that indicates acceptance of the offer of teleoperation service using the HID interface 216 of the device 104 or the interface of the device 106. If the offer is rejected, the process 750 may end, and the user will not be provided with teleoperation services during the trip unless alternative arrangements are made. If the offer is accepted, the process 750 may proceed to operation 755 in accordance with the input indicating acceptance of the offer of teleoperation service by the user. Thus, operations 755 and 756 may be performed in accordance with an input indicating acceptance of the offer of teleoperation service by the user or omitted if the input indicates rejection of the offer.

Operation 755 includes autonomously navigating towards the destination location while monitoring operation of the local autonomous system 224. Monitoring the local autonomous system 224 includes determining whether a disengagement of the local autonomous system 224 is predicted and determining whether an actual disengagement of the local autonomous system 224 has occurred. A predicted disengagement of the local autonomous system 224 means that it has been determined that the local autonomous system 224 may disengage in the near future (e.g., an imminent predicted disengagement), such as within a predetermined time or distance of travel after the prediction. An actual disengagement of the local autonomous system 224 means that the local autonomous system 224 is no longer in control of the device 104. A predicted disengagement may be determined based on the real-time disengagement likelihood metric 338. For example, the predicted disengagement may be determined when the real-time disengagement likelihood metric 338 for the local autonomous system 224 exceeds a threshold value. The real-time disengagement likelihood metric 338 may be determined in the manner described with respect to the process 650.

Operation 756 includes transitioning the device 104 from the autonomous control mode to a teleoperation control mode in response to a predicted disengagement or actual disengagement of the autonomous control mode during the trip. After transition of the device 104 to the teleoperation control mode, the device 104 is operated by a remote operator using the operator system 110 of the teleoperation service 102 to provide control inputs that are transmitted to the device 104 and used as a basis for determining the control commands 330 that cause operation of the actuator system 214 of the device 104.

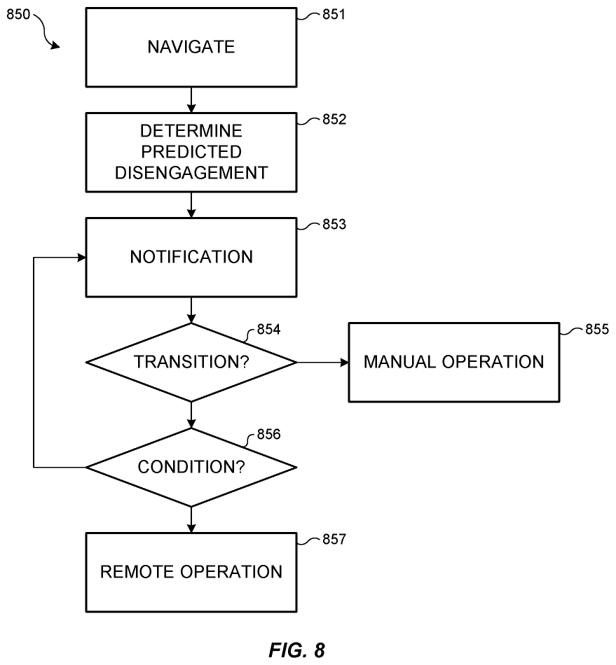

FIG. 8 illustrates exemplary process 850 for transitioning between control modes. The process 850 includes operations that can be performed by a computer-implemented system, such as the teleoperation service 102 and/or the device 104. In some implementations, the computer-implemented system that performs the process 850 has a memory that contains computer program instructions and one or more processors that are configured to execute the computer program instructions to cause the one or more processors to perform the operations of the process 850. The process 850 may include any of the features described herein, inclusive of the inputs, outputs, and models described with reference to FIGS. 3-4.

Operation 851 includes autonomously navigating towards a destination location while monitoring operation of the local autonomous system 224 in the autonomous control mode of the device 104 to determine whether an actual disengagement of the local autonomous system 224 has occurred or a predicted disengagement of the local autonomous system 224 has been determined. Operation 851 may include monitoring the real-time disengagement likelihood metric 338, which can be determined in the manner described with respect to the process 650.

Operation 852 includes determining a predicted disengagement of the autonomous control mode of the device 104. Operation 852 may include determining that the real-time disengagement likelihood metric 338 has exceeded a threshold value (e.g., a first threshold value), which indicates that disengagement of the local autonomous system 224 may occur in the near future such that the device 104 will no longer be operating in the autonomous control mode.

Operation 853 includes outputting a notification to a user requesting transition of the device 104 from the autonomous control mode to the manual control mode. The user may respond to the notification by taking control of the device 104, for example, by providing manual command inputs using the HID interface 216 of the device 104, in which case, the device 104 transitions to the manual control mode.

Outputting the notification to the user requesting transition of the device 104 from the autonomous control mode to the manual control mode may include at least one of emitting a sound, emitting a visual indication, or emitting a haptic indication. Outputting the notification to the user requesting transition of the device 104 from the autonomous control mode to the manual control mode may include outputting the notification using a component that is associated with the HID interface 216 of the device 104, such as by changing an illumination state in the passenger cabin, playing a sound in the passenger cabin, displaying a message on display screens in the passenger cabin, or causing vibration of a seat that is occupied by the user. Outputting the notification to the user requesting transition of the device 104 from the autonomous control mode to the manual control mode may include transmitting a command that causes the notification to be output by a device that is carried by the user, such as the device 106. For example, a haptic notification may be output by the device 106 while it is in possession of the user, such as by location of the device 106 in the user's pocket.

In operation 854, if the device 104 has transitioned to the manual control mode, the process continues to operation 855 where the device 104 is operated in the manual control mode and the process 850 ends. If the device has not yet transitioned to the manual control mode, the process continues to operation 856.

In operation 856, a determination is made as to whether a threshold condition has been satisfied. When operation 856 is executed, the device 104 is in the autonomous control mode and the user has not taken manual control. The threshold condition of operation 856 is used to judge whether the device 104 should transition to the teleoperation control mode in the event that the user has not responded to the notification. If the threshold condition is not satisfied, the process returns to operation 854 and additional iterations of operation 854 and operation 856 may be performed.

Determining that the threshold condition of operation 856 has been satisfied without transition of the device 104 to the manual control mode may include determining that a predetermined time period has passed. Determining that the threshold condition of operation 856 has been satisfied without transition of the device 104 to the manual control mode may include determining that a real-time disengagement likelihood metric 338 exceeds a threshold value (e.g., a second threshold value that is higher than the first threshold value). Determining that the threshold condition has been satisfied without transition of the device 104 to the manual control mode may include determining, based on sensor information from sensors that are in a passenger cabin of the device 104 and configured to observe the passenger cabin of the device 104, that the user is not responding. As one example, a seat sensor can indicate that a seat is occupied and it can be determined that the user is not responding based on inputs from the seat sensor that show low levels of user motion, by analysis of video images that show low levels of user motion, or by image classification techniques that determine, based on the video images, that the user is sleeping.

In operation 857, in accordance with the determination in operation 856 that the threshold condition has been satisfied without transition of the device 104 to the manual control mode, the operation of the device 104 is transitioned to the teleoperation control mode.

If transition to the teleoperation control mode is not possible (e.g., within a predetermined time period), the local autonomous system 224 may attempt to stop the device 104 in a safe location until operation can resume in one of the autonomous control mode, the manual control mode, or the teleoperation control mode. In some situations, attempts to transition to one or both of the manual control mode and the teleoperation control mode are skipped in lieu of stopping the device 104 at a safe location. In some situations, the order of operations may be changed so that transition from the autonomous control mode to the teleoperation control mode is attempted prior to attempting to transition to the manual control mode. In some situations, the device may be stopped in a safe location under autonomous control prior to attempting the transition from the autonomous control mode to the manual control mode or the teleoperation control mode.

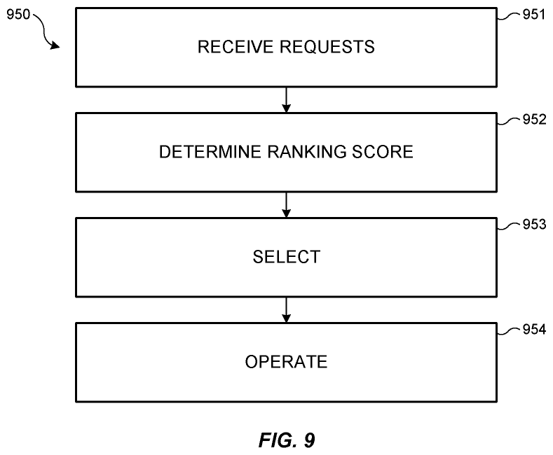

FIG. 9 illustrates exemplary process 950 for initiation of a teleoperation service. The process 950 includes operations that can be performed by a computer-implemented system, such as the teleoperation service 102 and/or the device 104. In some implementations, the computer-implemented system that performs the process 950 has a memory that contains computer program instructions and one or more processors that are configured to execute the computer program instructions to cause the one or more processors to perform the operations of the process 950. The process 950 may include any of the features described herein, inclusive of the inputs, outputs, and models described with reference to FIGS. 3-4.

Operation 951 includes receiving requests for initiation of teleoperation service that are transmitted to a teleoperation service from multiple devices that are equivalent to the device 104. At least some of the requests include the real-time disengagement likelihood metric 338 for the respective device to describe a likelihood that the autonomous control mode for the respective device will be disengaged. The real-time disengagement likelihood metric 338 can be determined in the manner described with respect to the process 650.

Operation 952 includes determining a ranking score for each of the requests for initiation of the teleoperation service. The ranking scores are based in part on the real-time disengagement likelihood metrics. The ranking scores may be based in part on an elapsed time since the request for initiation of the teleoperation service was made. Other information may be considered in determining the ranking scores. A factor based calculation, formula, algorithm, statistical model, or other calculation method may be used to determine the ranking scores.

Operation 953 includes selecting one of the devices for initiation of a teleoperation control mode according to the ranking score for the respective one of the devices (e.g., vehicles). Operation 954 includes operating the device selected in operation 953 in the teleoperation control mode by transmitting the teleoperation commands 337 to the device. Operating the selected devices in the teleoperation control mode by transmitting the teleoperation commands 337 to the respective one of the devices may be performed by a human operator using the operator system 110 that is associated with the teleoperation service 102.

FIG. 10 illustrates exemplary computing device 1060. The computing device 1060 is a hardware device that can be used to implement processing systems that are described herein, such as components of the teleoperation service 102, the device 104, or the device 106. In the illustrated example, the computing device 1060 includes a processor 1061, memory 1062, storage 1063, and communication devices 1064. The computing device 1060 may include other components, such as, for example, input devices and output devices.

The processor 1061 is configured to execute computer program instructions, and may be or include one or more conventional devices and/or special-purpose devices configured to execute computer program instructions. Conventional devices that can be used as a basis for implementing the processor 1061 include one or more central processing units, one or more graphics processing units, one or more application specific integrated circuits, and/or one or more field programmable gate arrays. The memory 1062 is a conventional short-term storage device that stores information for the processor 1061, such as random-access memory modules. Long-term non-volatile storage is provided by the storage 1063, which may be, for example, a flash memory module, a hard drive, or a solid-state drive. The communication devices 1064 are wired or wireless devices configured to facilitate communications between the computing device 1060 and other components or systems, such as by sending and receiving data.

The computing device 1060 is operable to store, load, and execute computer program instructions. When executed by the computing device 1060, the computer program instructions cause the computing device to perform operations, such as obtaining information by accessing the information from a storage device, accessing the information from short-term memory, receiving a wired or wireless transmission that includes the information, receiving signals from an input device that represent user inputs, and receiving signals from the sensors that represent observations made by the sensors. The operations that can be performed by the computing device 1060 may include making a determination, such as by comparing a value to a threshold value, comparing states to conditions, evaluating one or more input values using a formula, evaluating one or more input values using an algorithm, and/or making a calculation using data of any type.

The operations that can be performed by the computing device 1060 may also include transmitting information, for example, using a data bus, using a wired data transmission, or using a wireless data transmission. The operations that can be performed by the computing device 1060 may also include outputting a signal to control a component, such as by outputting a signal that causes a sensor to take a measurement, outputting a signal that causes a camera to capture an image, or outputting a signal that causes operation of an actuator, such as by commanding the actuator to start moving, stop moving, set a speed value, set a torque value, or move to a particular position that is specified by the signal. The operations that can be performed by the computing device 1060 may also include outputting a display signal that causes a display component to display content, such as by outputting the signal to a light-emitting display panel, a projector, or other type of display device that is able to display content in a manner that can be seen by a person.

The teleoperations systems described herein may include gathering, storing, and using data available from various sources. Implementers are reminded that, to the extent personal information data is used to provide teleoperations functionality, the information should be used in ways that comport with applicable privacy laws and practices. For example, the system may require users to opt-in (e.g., to provide consent) before carrying out certain features. The system may also allow users to opt-out while providing other features where possible. These activities should be conducted in accordance with privacy policies and practices that meet or exceed industry or governmental requirements regarding privacy and security of personal information data.

What is claimed is:

1. A computer-implemented method, comprising:
determining a predicted disengagement of an autonomous control mode of a vehicle;
outputting a notification requesting transition of the vehicle from the autonomous control mode to a manual control mode;
determining that a threshold condition has been satisfied without transition of the vehicle to the manual control mode; and
in accordance with the determination that the threshold condition has been satisfied without transition of the vehicle to the manual control mode, transitioning the vehicle to a teleoperation control mode.

2. The computer-implemented method of claim 1, wherein the predicted disengagement is determined when a real-time disengagement likelihood metric exceeds a threshold value.

3. The computer-implemented method of claim 2, wherein the real-time disengagement likelihood metric is expressed as a probability that the autonomous control mode of the vehicle will disengage within a predetermined period.

4. The computer-implemented method of claim 2, further comprising:
autonomously navigating towards a destination location while monitoring the real-time disengagement likelihood metric prior to determining the predicted disengagement of the autonomous control mode of the vehicle.

5. The computer-implemented method of claim 1, wherein determining that the threshold condition has been satisfied without transition of the vehicle to the manual control mode includes determining that a predetermined time period has passed.

6. The computer-implemented method of claim 1, wherein determining that the threshold condition has been satisfied without transition of the vehicle to the manual control mode includes determining that a real-time disengagement likelihood metric exceeds a threshold value.

7. The computer-implemented method of claim 1, wherein determining that the threshold condition has been satisfied without transition of the vehicle to the manual control mode includes determining, based on sensor information from sensors that are located in a passenger cabin of the vehicle, that a user is not responding.

8. A non-transitory computer-readable storage device including program instructions executable by one or more processors that, when executed, cause the one or more processors to perform operations, the operations comprising:
determining a predicted disengagement of an autonomous control mode of a vehicle;
outputting a notification requesting transition of the vehicle from the autonomous control mode to a manual control mode;
determining that a threshold condition has been satisfied without transition of the vehicle to the manual control mode; and
in accordance with the determination that the threshold condition has been satisfied without transition of the vehicle to the manual control mode, transitioning the vehicle to a teleoperation control mode.

9. The non-transitory computer-readable storage device of claim 8, wherein the predicted disengagement is determined when a real-time disengagement likelihood metric exceeds a threshold value.

10. The non-transitory computer-readable storage device of claim 9, wherein the real-time disengagement likelihood metric is expressed as a probability that the autonomous control mode of the vehicle will disengage within a predetermined period.

11. The non-transitory computer-readable storage device of claim 9, further comprising:
autonomously navigating towards a destination location while monitoring the real-time disengagement likelihood metric prior to determining the predicted disengagement of the autonomous control mode of the vehicle.

12. The non-transitory computer-readable storage device of claim 8, wherein determining that the threshold condition has been satisfied without transition of the vehicle to the manual control mode includes determining that a predetermined time period has passed.

13. The non-transitory computer-readable storage device of claim 8, wherein determining that the threshold condition has been satisfied without transition of the vehicle to the manual control mode includes determining that a real-time disengagement likelihood metric exceeds a threshold value.

14. The non-transitory computer-readable storage device of claim 8, wherein determining that the threshold condition has been satisfied without transition of the vehicle to the manual control mode includes determining, based on sensor information from sensors that are located in a passenger cabin of the vehicle, that a user is not responding.

15. An apparatus, comprising:
a memory; and
one or more processors that are configured to execute instructions that are stored in the memory, wherein the instructions, when executed, cause the one or more processors to:
determine a predicted disengagement of an autonomous control mode of a vehicle,
output a notification request transition of the vehicle from the autonomous control mode to a manual control mode,
determine that a threshold condition has been satisfied without transition of the vehicle to the manual control mode, and
in accordance with the determination that the threshold condition has been satisfied without transition of the vehicle to the manual control mode, transition the vehicle to a teleoperation control mode.

16. The apparatus of claim 15, wherein the predicted disengagement is determined when a real-time disengagement likelihood metric exceeds a threshold value.

17. The apparatus of claim 16, wherein the real-time disengagement likelihood metric is expressed as a probability that the autonomous control mode of the vehicle will disengage within a predetermined period.

18. The apparatus of claim 16, wherein the instructions further cause the one or more processors to:
autonomously navigate towards a destination location while the real-time disengagement likelihood metric is monitored prior to the determination of the predicted disengagement of the autonomous control mode of the vehicle.

19. The apparatus of claim 15, wherein the determination that the threshold condition has been satisfied without transition of the vehicle to the manual control mode includes a determination that a predetermined time period has passed.

20. The apparatus of claim 15, wherein the determination that the threshold condition has been satisfied without transition of the vehicle to the manual control mode includes a determination that a real-time disengagement likelihood metric exceeds a threshold value.

21. The apparatus of claim 15, wherein the determination that the threshold condition has been satisfied without transition of the vehicle to the manual control mode includes a determination, based on sensor information from sensors that are located in a passenger cabin of the vehicle, that a user is not responding.
